(19) United States
(12) Patent Application Publication
(10) Pub. No.: US 2008/0222107 A1
(43) Pub. Date: Sep. 11, 2008

(54) Method for Multiplexing Search Result Transmission in a Multi-Tier Architecture

(76) Inventor: David A. Maluf, Mountain View, CA (US)

Correspondence Address: Zilka-Kotab, PC, P.O. BOX 721120, SAN JOSE, CA, 95172-1120, US

(21) Appl. No.: 11/781,041

(22) Filed: Jul. 20, 2007

Related U.S. Application Data
(60) Provisional application No. 60/820,079, filed on Jul. 21, 2006.

(51) Int. Cl. G06F 17/30

(52) U.S. Cl. 707/3

(57) ABSTRACT

A method for querying a database comprises receiving a query from a client, querying a plurality of databases, receiving replies from the databases, relaying the replies from the databases to the client as they are received from the databases. A system for querying a database comprises a client, a plurality of databases, and a query dispatcher receiving a query from the client, querying the plurality of databases, receiving replies from the databases, relaying the replies from the databases to the client as they are received from the databases.

### RELATED APPLICATIONS

This application claims priority to U.S. Provisional Patent Application 60/820,079, filed Jul. 21, 2006.

### FIELD OF THE INVENTION

This invention relates to distributed database queries in a multi-tier environment.

### BACKGROUND

Modern client applications such as web browsers and really simple syndication (RSS) readers request information in the Hypertext Markup Language (HTML) or Extensible Markup Language (XML) from a single web server using the hypertext transfer protocol (HTTP), a lightweight and simple protocol where individual transactions return individual results. With large-scale databases such as search engines, however, computing the result of the request is an expensive operation that is best addressed by multiple back-end computers and the task of distributing the work and responding to the request with a unified response requires a middle tier system that must act as an intermediary, distributing the request to the back-end systems and consolidating the results in a consistent manner for delivery to the client.

The activity of consolidating the asynchronous results returned by the back-end into a consistent, logical, and valid set of data for consumption by the client is a challenging task. Each back-end system will be returning the results in a piecemeal fashion, often returning a subset of the results after some delay. The middle tier must combine these individual results together so that each is kept whole and distinct from other results but appear to be a part of a single result set, and the entire result set must comply with the syntactic requirements of the output format (be valid XML or HTML). A common solution to this is to have the middle tier accumulate the results from each back-end and, once a complete result is accumulated, send that accumulated result to the client,

In the ease of result sets that require consolidation or ordering or other operations, the middle tier may need to accumulate all results from all back-ends before delivering the results to the client. This is, in and of itself, time and resource intensive and requires a considerably large computing system.

The protocol between the middle tier and the back-end may be proprietary and hidden from the clients.

### Current State of the Art: Sequence of Events

Step 1: Referring to FIG. 1A, the client 12, usually a desktop environment such as a web browser, RSS reader, XML application, etc, requests data from the middle tier 14 with query parameters defining the type of information that is being requested. The middle tier connects to the databases 16 and hands off the request information relevant to find the information requested.

Step 2: Referring to FIG. 1B, the backend database systems begin to return results out of the sort order. In this example, the middle tier 14 accumulates the results until all databases 16 have returned their results in order to sort those results. Database 4 has indicated that it has no results. The client 12 has yet to receive any results.

Step 3: Referring to FIG. 1C, further results arrive from other databases 16 and databases indicate that they have returned all results they have available.

Step 4: Referring to FIG. 1D, all backend database systems complete and indicate the end to their individual results.

Step 5: Referring to FIG. 1E, the results are sorted and delivered to the client, completing the response to the request. The client 12 receives no data from the server (beyond, perhaps, status or other keep-alive messages) until this step.

### DESCRIPTION OF THE DRAWINGS

For a fuller understanding of the nature and advantages of the present invention, as well as the preferred mode of use, reference should be made to the following detailed description read in conjunction with the accompanying drawings.

FIGS. 1A-E are graphic depictions of data request processing.

FIG. 2 illustrates a network architecture, in accordance with one embodiment.

FIG. 3 shows a representative hardware environment associated with a user device of FIG. 2, in accordance with one embodiment.

FIGS. 4A-D are graphic depictions of data request processing according to an embodiment.

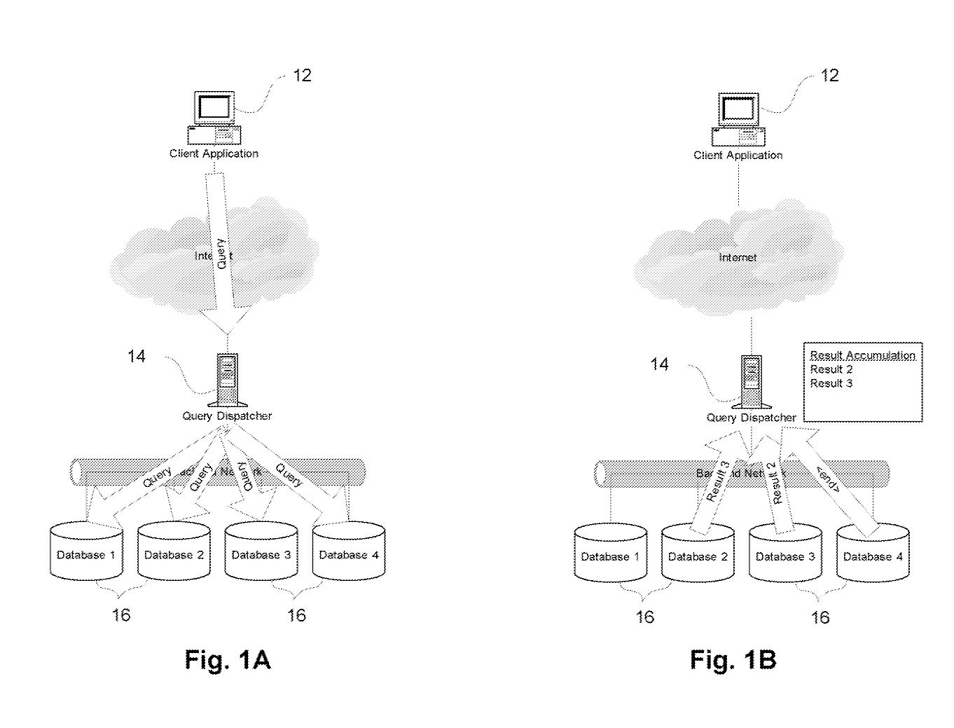

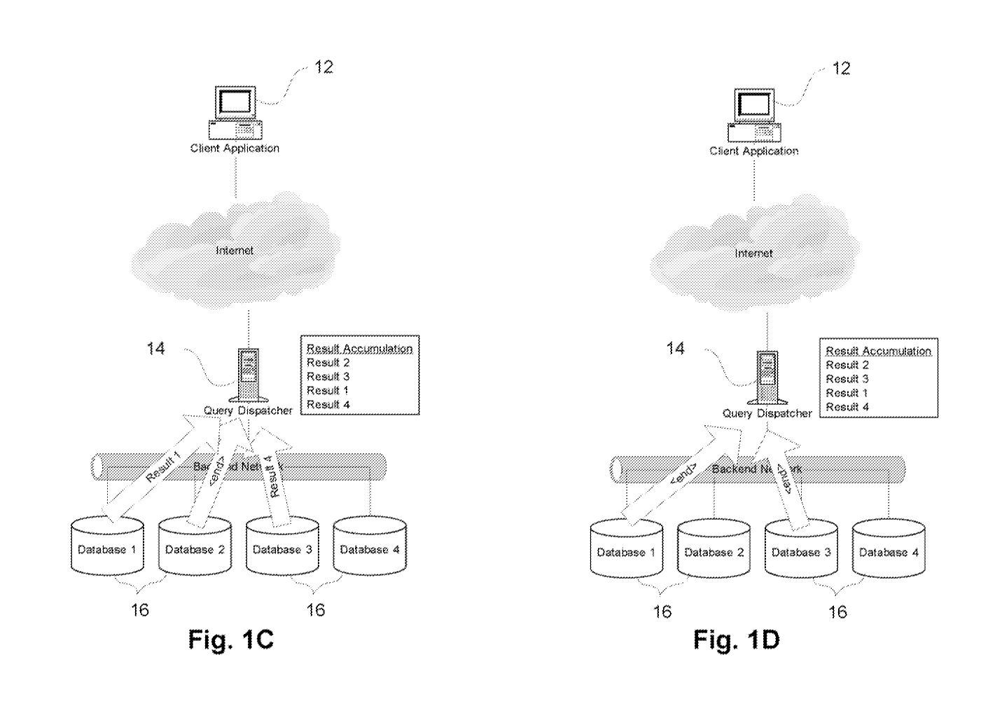

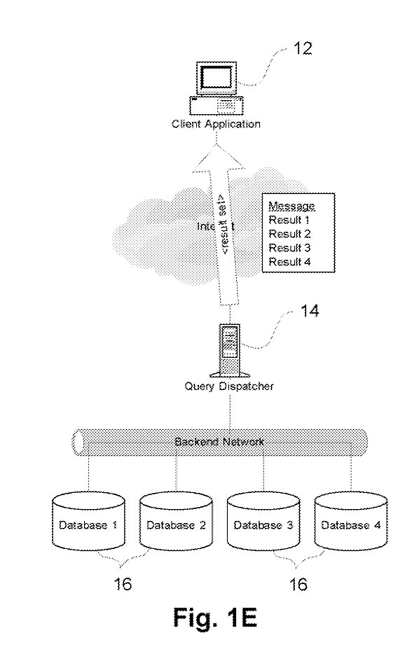

### DETAILED DESCRIPTION

The following description is the best mode presently contemplated for carrying out the present invention. This description is made for the purpose of illustrating the general principles of the present invention and is not meant to limit the inventive concepts claimed herein. Further, particular features described herein can be used in combination with other described features in each and any of the various possible combinations and permutations.

The following description is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed below are implemented using the internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which a present embodiment of the invention is executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing either a combination of microprocessors or other specially designed application specific integrated circuits, programmable logic devices, or various combinations thereof. In particular, methods described herein may be implemented by a series of computer-executable instructions residing on a storage medium such as a carrier wave, disk drive, or computer-readable medium. Exemplary forms of carrier waves may be electrical, electromagnetic or optical signals conveying digital data streams along a local network or a publicly accessible network such as the Internet. In addition, although specific embodiments of the invention may employ object-oriented software programming concepts, the invention is not so limited and is easily adapted to employ other forms of directing the operation of a computer.

The invention can also be provided in the form of a computer program product comprising a computer readable medium having computer code thereon. A computer readable medium can include any medium capable of storing computer code thereon for use by a computer, including optical media such as read only and writeable CD and DVD, magnetic memory, semiconductor memory (e.g., FLASH memory and other portable memory cards, etc.), etc. Further, such software can be downloadable or otherwise transferable from one computing device to another via network, wireless link, nonvolatile memory device, etc.

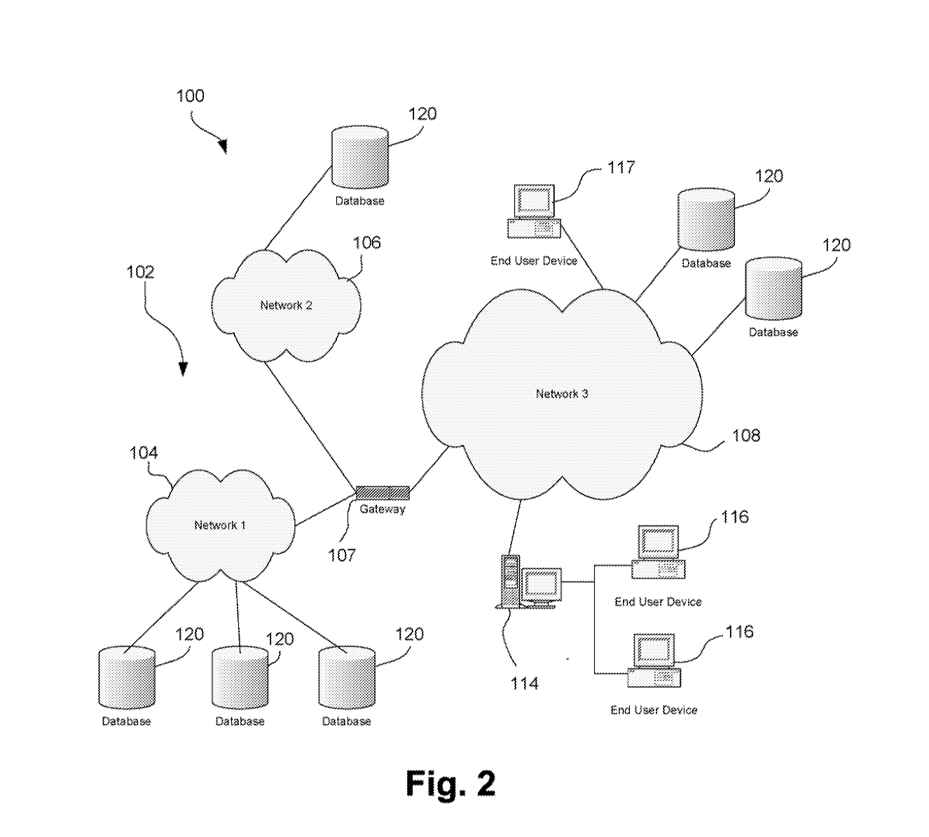

FIG. 2 illustrates a network architecture 100, in accordance with one embodiment. As shown, a plurality of remote networks 102 are provided including a first remote network 104 and a second remote network 106. Also included is at least one gateway 107 coupled between the remote networks 102 and a proximate network 108. In the context of the present network architecture 100, the networks 104, 106 may each take any form including, but not limited to a local area network (LAN), a wide area network (WAN) such as the Internet, etc.

In use, the gateway 107 serves as an entrance point from the remote networks 102 to the proximate network 108. As such, the gateway 107 may function as a router, which is capable of directing a given packet of data that arrives at the gateway 107, and a switch, which furnishes the actual path in and out of the gateway 107 for a given packet.

Further included is at least one data server 114 coupled to the proximate network 108, and which is accessible from the remote networks 102 via the gateway 107. It should be noted that the data server(s) 114 may include any type of computing device/groupware. Coupled to each data server 114 is a plurality of user devices 116. Such user devices 116 may include a desktop computer, lap-top computer, hand-held computer, printer or any other type of logic. It should be noted that a user device 117 may also be directly coupled to any of the networks, in one embodiment.

A database 120 or series of databases 120 may be coupled to one or more of the networks 104, 106, 108. It should be noted that additional databases and/or components thereof may be utilized with, or integrated into, any type of network element coupled to the networks 104, 106, 108. In the context of the present description, a network element may refer to any component of a network.

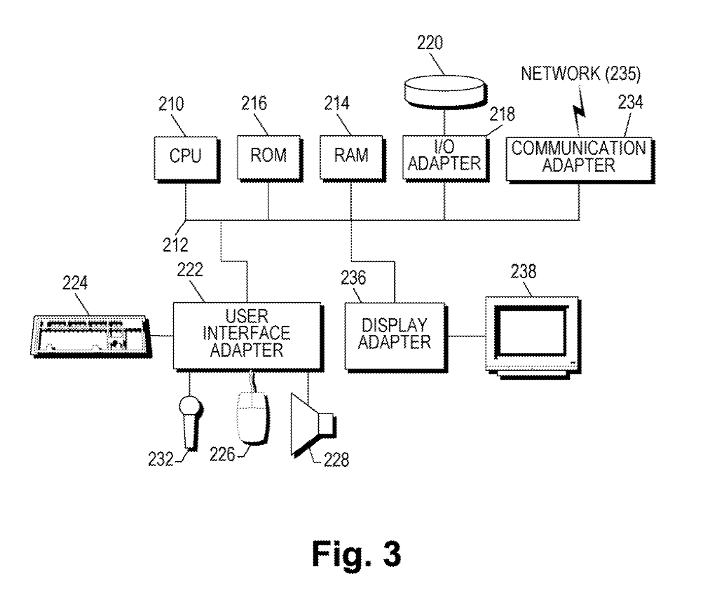

FIG. 3 shows a representative hardware environment associated with a user device 116 of FIG. 2, in accordance with one embodiment. Such figure illustrates a typical hardware configuration of a workstation having a central processing unit 210, such as a microprocessor, and a number of other units interconnected via a system bus 212.

The workstation shown in FIG. 3 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, or UNIX operating system. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

In small installations it may be beneficial to enable direct communications to a single back-end system or enable more intelligent clients to communicate to all of the back-end systems directly (acting much like this middle tier.) In order to facilitate multiple configurations of this type, a preferred embodiment uses XML at each stage of communication.

In configurations where the client is burdened with other duties, or where the middle tier is an appliance with limited resources (memory, compute power), embodiments of the present invention may change the paradigm of the middle tier so that it does not need to accumulate results from the back-end systems. In cases where the results simply need to be accumulated and delivered, not ordered or consolidated, the approach is a mechanism of signaling between the back-end and the middle tier so that the middle tier does not need to accumulate data and would, instead, await a signal from a back-end that, a completed result is available and switch to the next input. If data is not available or the signal of completion is set, the middle tier moves to the third source and so on. To switch among sources, signals and patterns are decoded from the stream or any other method for notify the middle tier.

The balance of the multiplexer is defined by identifying statistically or any other approach on the likely size of a packet from a data source. Estimation of the packet size, the available bandwidth and middle tier computational capabilities, the total number of sources could be identified as:

[Total Number of Sources]×[Likely Packet Size/sec]=MIN {[Middle tier CPU], [Bandwith]} (units Bytes/sec)

When a result is available from any of the back-end systems, the middle tier will simply stream the result from the back-end to the client knowing that the result is complete and available for delivery. This “signal” channel would be a second HTTP connection between the middle tier and the back-end, with the “data channel” being a standard HTTP connection for the request and results. Upon delivery of a result over the data connection, the back-end would send the number of bytes in that result over the signal channel indicating how much must be relayed by the middle tier in order to deliver a complete result to the client. The signal channel can also be used to monitor the quality and other status indicators so that in the case where the back-end system is overburdened and will not be able to respond in a timely fashion, the middle tier system can use a redundant fallback system and/or return partial results with an indication of the status to the client.

### High-Performance Multiplexing Architecture: Sequence of Events

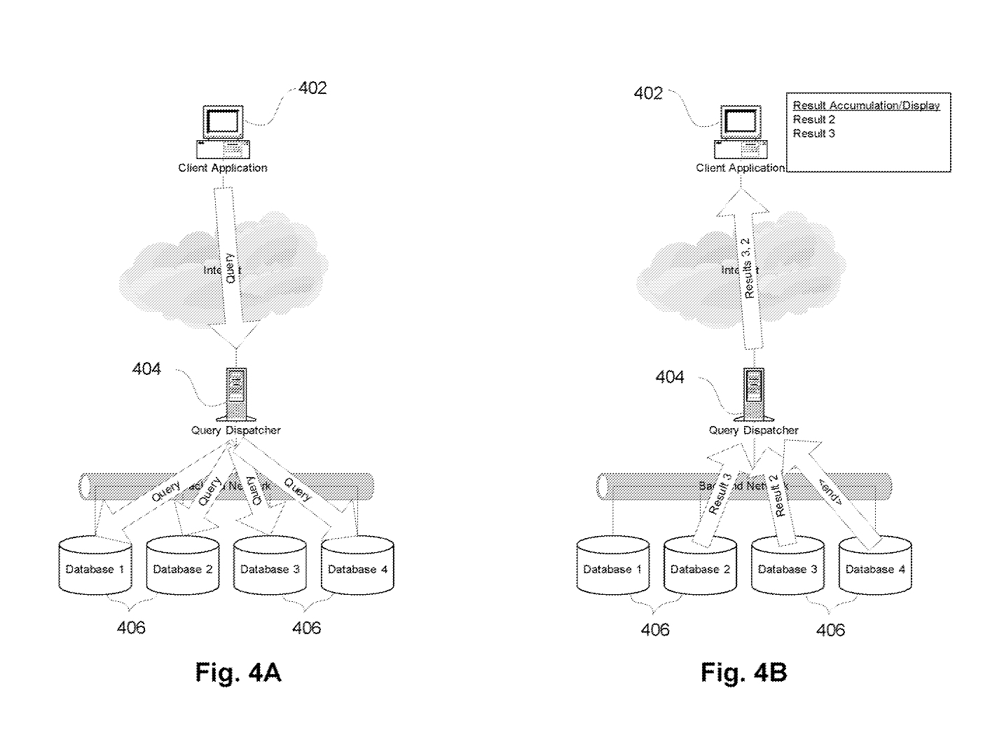

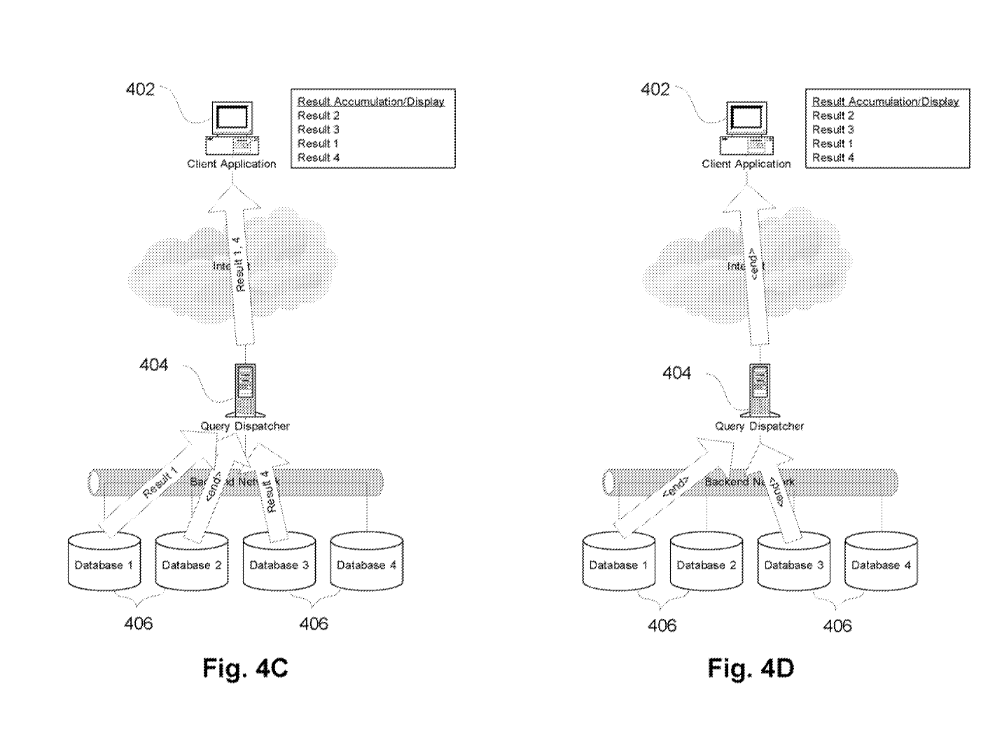

Step 1: Referring to FIG. 4A, the client 402 makes a request of the middle tier 404 and that middle tier connects to the databases 406 and hands off the request information relevant to find the information requested. The request may be submitted by any client application, including web browsers and really simple syndication (RSS) readers requesting information in the HyperText Markup Language (HTML) or Extensible Markup Language (XML), typically performed at a user's request. Other examples of client applications include automated programs such as, but not limited to, data mining programs, applications containing pointers to data in one or more of the databases, etc. The query may any type of request, including, but not limited to, keyword search request, specific filename request, file or data type request, file size-based request, partition-specific request, etc.

Step 2: Referring to FIG. 4B, the backend database systems 406 begin to return results out of the sort order. In this example, the middle tier 404 immediately relays each result to the client 406 as they are received (often not in any particular order). The client may have the option, as it receives these results, to perform its own sort operation as results are received. Many user interfaces allow for progressive updates of the results as they arrive, providing immediate feedback to the user. The results may be any kind of results, including but not limited to entire files, file name, paths or pointers to files, portions of files, specific types of files, etc.

Step 3: Referring to FIG. 4C, further results arrive from other databases 106 and databases indicate that they have returned all results they have available.

Step 4: Referring to FIG. 4D, all backend database systems 406 complete and indicate the end to their individual results. The middle tier 404 indicates an end of results to the client 402 and the client is free to do with the data what it wishes. This may include outputting the results to a visual display device displaying a graphical user interface.

The following description illustrates various features which may be implemented in embodiments of the present invention. It should not be implied that any particular feature or combination of features is necessary or required to be present in any embodiments of the present invention, but rather that various embodiments may include one or more of the following features in any combination.

One purpose of the system or method according to an embodiment and API is to enable users to retrieve specific and precise information from within the contents of documents spread across disparate systems. A user can use a browser and appropriate syntax to create a custom application focused on local and general needs, with minimal effort. Using the system or method according to an embodiment may provide developers with the ability to:
Use a standard set of programming patterns and practices
Query unstructured information in data repositories based on both contest and content
Re-compose new documents from the results of the queries
Publish information to the ‘Subscribers,” using queries to combine relevant information from different sources into custom documents.

The system preferably enables:
Users to select and integrate contents from proprietary electronic information software systems using a standard browser
Both end users and industry Developers to use a custom UI in their web browsers to execute features of a system or method according to an embodiment
Developers to design queries that require the existing systems to share information in a way not possible now
Users to ‘subscribe’ to new documents created by the queries, receiving a new one when the basic information is updated.

### OVERVIEW OF A PREFERRED EMBODIMENT

Assumptions and Constraints

The system or method according to an embodiment may be designed to function as a ‘universal interface,’ if the categories of assumptions shown below are met.

### Security Assumptions

Two-way encryption and other security measures are in place.
The environment includes the latest security patches on browser clients and relevant web servers.
The Developer has the appropriate network; and server permissions, knows the names of the development server and how to specify the location of other components in the development environment.

### Computing Environment Assumptions

The Administrator has enabled functioning WebDAV client (typically a Microsoft Web Folder) so the information can reach the DAV service on the server.

### Development Process Assumptions

The Developer bases the query on proper syntax for EXtensible Markup Language (XML).
The Developer applies the appropriate user-defined XML query command functions to filter out redundant data, navigate through the XML tree structures, and yield a more precise search result.
The Developer applies the appropriate XSLT style sheet to transform the node sets from the query into the desired XML/HTML format.

### Constraints

Restraints may include:

1. ASYNCHRONOUS: must be used with all queries.

2. KEYWORDS: requires the use of spaces, not underscores

3. XML:
Use CDATA to ‘escape’ special characters so they can be used in XML

4. SENSITIVTY:
XML is designed for use with queries of XML files, with the following constraints:
   XML is case sensitive
   XML does support attributes in XML tags
   The system or method may not require the use of quotation marks for strings and extra space at the end of a string
   XML requires the use of XML FORMAT QUERY
   EXCEPTION: do not use XML FORMAT QUERY when querying non-XML files.

### How To Create Welt Formed Queries

### HTTP and HTTP-DAV Transactions

### Types of Transaction

The system architecture according to one embodiment may permit the following types of asynchronous transactions:

OPTIONS, GET, HEAD, POST, PUT, DELETE, MKCOL, MOVE, COPY, PROPFIND, NAS.0, NAS.1, LOCK, UNLOCK, PROPPATCH

OPTIONS methods to access the available options *

GET to fetch resources *

HEAD to verify if resource exists

POST to submit resources

PUT to submit a resource *

DELETE to delete a resource

MKCOL to create a collection (directory or folder)

MOVE to rename a resource

COPY to copy a resource

PROPFIND to fetch property definition of a resource in XML *

NAS.0 and NAS.1 Neighborhood registry with other devices

LOCK to lock a resource temporarily

UNLOCK to unlock a resource temporarily

PROPPATCH to patch a resource properties (disabled)

### Transaction Criteria

Select the appropriate type of asynchronous transaction based on the following user requirements:
Fundamentally to get or submit information that my system indicates is or Is not the database.
Find information related to my scope that has been deleted.
Find information from either of the above options, but return it to me combined into a highly formatted new document, including HTML, Macromedia Flash, Word documents, Excel documents, or PowerPoint documents.
Find information from either of the first two options, but return it to me as a functioning webpage with internal links
Other requirement, such as record identifier
Other requirement, such as another type of format for the results
These transaction are W3C Standard for the exception of NAS.0 and NAS.1

### Options

### Purpose

This section specifies the discovery methods for the set of methods, headers, and content-types ancillary to HTTP/1.1 for the management of resource properties, creation and management of resource collections, namespace manipulation, and resource locking (collision avoidance).

The following table sets forth illustrative syntax:

TABLE 1

| | |
|---|---|
| Syntax | Request |
| HTTP Header | OPTIONS / HTTP/1.1 |
| | Accept: */* |
| | Connection: keep-alive |
| | Content-Length: 0 |
| | Host: www.sciencegate.com:80 |
| | User-Agent: WebDAVFS/1.3.1 (01318000) |
| | Darwin/8.5.0 (Power Macintosh) |
| | Response Failed Authentication |
| | HTTP/1.1 401 Authorization Required |
| | Date: Wed, 07 Jun 2006 08:42:36 PDT |
| | Server: Fastxi/2.7 Science Gate Bay (Unix) |
| | WWW-Authenticate: Basic Realm=“directory/” |
| | Content-Length: 0 |
| | Content-Type: text/plain; charset=ISO-8859-1 |
| | Connection: close |
| | Response Passed Authentication |
| | HTTP/1.1 200 OK |
| | Date: Wed, 07 Jun 2006 08:42:40 PDT |
| | Server: Fastxi/2.7 Science Gate Bay (Unix) |
| | Allow: |
| | OPTIONS,HEAD,GET,PUT,DELETE,MKCOL,MOVE, |
| | COPY,PROPFIND,PROPPATCH,LOCK,UNLOCK |
| | DAV: 2 |
| | MS-Author-Via: DAV |
| | Content-Length: 0 |
| | Content-Type: text/plain; charset=ISO-8859-1 |
| | Connection: close |

### Instruct to Initiate Transaction

Do not omit this required syntax.
Begin HTTP discovery request with this syntax.

### More Information

See http://www.w3.org/Protocols/ for more information, and which is herein incorporated by reference.

### Propfind

### Purpose

This section specifies the resource discovery, content and content-types ancillary to HTTP/1.1 for the management of resource properties, creation and management of resource collections, namespace and manipulation.

The following table sets forth illustrative syntax:

TABLE 2

| | |
|---|---|
| Syntax | Request |
| HTTP | PROPFIND / HTTP/1.1 |
| Header | Accept: */* |
| | Authorization: Basic bWFsdWY6bWFsdWY= |
| | Connection: keep-alive |
| | Content-Length: 161 |
| | Content-Type: text/xml |
| | Depth: 0 |
| | Host: www.sciencegate.com:80 |
| | User-Agent: WebDAVFS/1.3.1 (01318000) |
| | Darwin/8.5.0 (Power Macintosh) |
| | Response |
| | HTTP/1.1 207 Multi-Status |
| | Date: Wed, 07 Jun 2006 08:42:40 PDT |
| | Server: Fastxi/2.7 Science Gate Bay (Unix) |
| | DAV: 2 |
| | MS-Author-Via: DAV |
| | Content-Length: −1 |
| | Content-Type: text/plain; charset=ISO-8859-1 |
| | Connection: close |
| | <?xml version=“1.0” encoding=“utf-8” ?> |
| | <D:multistatus xmlns:D=“DAV:”> |
| | <D:response> |
| | <D:href>http://www.sciencegate.com:80/</D:href> |
| | <D:propstat> |
| | <D:prop> |
| | <D:creationdate></D:creationdate> |
| | <D:getlastmodified>Wed, 25 Jan 2006 21:48:06 |
| | PST</D:getlastmodified> |
| | <D:resourcetype> |
| | <D:collection></D:collection></D:resourcetype> |
| | <D:contenttype></D:contenttype> |
| | <D:getcontentlength>238</D:getcontentlength></D:prop> |
| | <D:status>HTTP/1.1 200 OK</D:status> |
| | </D:propstat> |
| | </D:response> |
| | </D:multistatus> |

### Instruct to Initiate Transaction

Do not omit tins required syntax.
Begin HTTP resource discovery with this syntax.

### More Information

See http://www.w3.org/Protocols/ for more information, and which is herein incorporated by reference.

### Put, MKCOL, Move and Delete

### Purpose

This section specifies the methods for the management of resource properties, creation and management of resource collections, namespace manipulation.

The following table sets forth illustrative syntax.

TABLE 3

| | |
|---|---|
| Syntax | Request |
| HTTP | PUT /myfilename.xml HTTP/1.1 |
| Header | Accept: */* |
| | Authorization: Basic bWFsdWY6bWFsdWY= |
| | Connection: keep-alive |
| | Content-Length: 0 |
| | Host: www.sciencegate.com:80 |
| | User-Agent: WebDAVFS/1.3.1 (01318000) |
| | Darwin/8.5.0 (Power Macintosh) |
| | Response |
| | HTTP/1.1 201 Created |
| | Date: Wed, 07 Jun 2006 08:42:41 PDT |
| | Server: Fastxi/2.7 Science Gate Bay (Unix) |
| | Location: http://www.sciencegate.com:80/myfilename.xml |
| | Content-Length: 0 |
| | Content-Type: text/plain; charset=ISO-8859-1 |
| | Connection: close |

### Instruct to Initiate Transaction

Do not omit this required syntax.
Begin HTTP resource manipulation with this syntax.

### More Information

See http://www.w3.org/Protocols/ for more information, and which is herein incorporated by reference.

### Get

### Purpose

This section specifies the methods for the management of resource properties, creation and management of resource collections, namespace manipulation.

The following table sets forth illustrative syntax:

TABLE 4

| | |
|---|---|
| Syntax | Request |
| HTTP Header | Get /myfilename.xml HTTP/1.1 |
| | Accept: */* |
| | Authorization: Basic bWFsdWY6bWFsdWY= |
| | Connection: keep-alive |
| | Host: www.sciencegate.com:80 |
| | User-Agent: WebDAVFS/1.3.1 (01318000) |
| | Darwin/8.5.0 (Power Macintosh) |
| | Response |
| | HTTP/1.1 200 OK |
| | Date: Wed, 07 Jun 2006 08:42:41 PDT |
| | Server: Fastxi/2.7 Science Gate Bay (Unix) |
| | DAV: 2 |
| | MS-Author-Via: DAV |
| | Content-Length: 0 |
| | Content-Type: text/plain; charset=ISO-8859-1 |
| | Connection: close |

### Instruct to Initiate Transaction

Do not omit this required syntax.
Begin HTTP resource access with this syntax.

### More Information

See http://www.w3.org/Protocols/ for more information, and which is herein incorporated by reference.

### How To Create Well Formed Queries

### XML Query

### Types of Searches

### Types of Searches

The system architecture may permit the following types of searches:
Is inherently GET or POST method
Starts with an /ofxi! URL Request method
XML tag search only search (node)
XML text search only search (data)
Combined node and data search
XML pattern recognition combination search
XML attribute search
Range value search
UI Processing on the query options (client side)

### Search Selection Criteria

Select the appropriate type of system or method based on the following user requirements:
Find information that my system indicates is already in a database.
Find information related to my scope that has been deleted.
Find information from either of the above options, but return it to me combined into a highly formatted new document, including HTML, Macromedia Flash, Word documents, Excel documents, or PowerPoint documents.
Find information from either of the first two options, but return it to me as a functioning webpage with internal links
Other requirement, such as record identifier
Other requirement, such as another type of format, for the results

### Creating Well-Formed Queries

### Well-Formed Query

All queries must conform to the syntax recognizable by the system.
Note: The items are separated by | require the Developer to make a selection between the items shown
The full syntax for creating a query is as follows:

```
BASIC QUERY SYNTAX
        http://<server_address>/
        ofxi?{[node=<node and attibute keys>]|
          [&data=<keys>]}|
          [&udri=<unique database record identifier >]
ADVANCED QUERY SYNTAX
        http://<server_address>/
        ofxi?{[node=<node and attribute keys>]|
          [&data=< keys>]}|
          [&modx=<xml pattern matching>]}|
          [&udri=<unique database record identifier >]
```

### Query Conventions

### Query Syntax Conventions

The syntax may include the following conventions:

TABLE 5

| Expression | Meaning |
|---|---|
| Free Text | Key words used as required constant |
| Text between < > | Value substituted by actual value |
| Text between [ ] | Parameter for range evaluation |
| Text between { \| } | Split text from UDRI |
| Text between “ “ | Treat text as whole object |

Note:
the | symbol indicates optional choices and should not be included in the text of the query because the query will not execute.

Note: a comma separates elements in the results field so that the query will operate in an Oracle environment

### Before You Begin

Developers should obtain the required information to compose a well-formed query:
the source of the information, expressed as a fully qualified path
the content and context to search
the key word filtering requirements for the elements in an ‘advanced search’
the required format for displaying the results
the need for post query processing, either on the server or the user's client desktop.

### Annotated Command Reference

### Introduction to Command Reference

### Annotated Command Reference

Each Query command component has its own section.

Each includes the following contents:
Component name and spelling
Syntax
Instructions to create
Cautions
Notes
Best Practices
Links to further information component
Examples.

### HTTP[S]://

### Purpose

Starting the query with http[s]://
Indicates you are using the Secure Hypertext Transfer Protocol and will run the query in a browser.
Enables the system or method to send and receive a query request to or from a central or remote location at any time, anywhere around the world.

The following table sets forth illustrative syntax:

TABLE 6

| | |
|---|---|
| Syntax | http[s]:// |

### Instruct to Initiate Transaction

Do not omit this required syntax.
Begin each query with this syntax.

### More Information

See http://www.w3.org/Protocols/ for more information, and which is herein incorporated by reference.

### Server_address

### Purpose

Use the Server_address parameter to:
To identify the server in your work location that functions as the “host” and to specify the port on which this server communicates.
To use the correct port and ensure security for communications between the server and the rest of the a networked computing infrastructure.

The following table sets forth illustrative syntax:

TABLE 7

| | |
|---|---|
| Syntax | <server_address> |
| | —————————————————————————— |

### Instruct to Specify Host Name

Do not omit this required syntax.
Replace “server_address” with the name of the server

### EXAMPLES

Because XML queries are used for applications, see the section that contains Customer-specific examples.

### XSLT

### Purpose

Use the /xslt parameter to:
To specify that the results of the query must be transformed from XML format, using a specific style sheet.
To specify post-processing of the query results, in this case on the Server.

The following table sets forth illustrative syntax:

TABLE 8

| | |
|---|---|
| Syntax | /xslt/ |

### Instruct to Produce XML Output

### See Also &sxslt

The &sxslt parameter specifies server-side post-processing of the query

### EXAMPLES

Because queries are used in applications, see the section that contains Customer-specific examples.

### Node

### Purpose

Use the node portion of the query syntax to specify Key Words to set:
either node, data or modx
or a combination of the three.

If there is more than one context, use the syntax &node

The following table sets forth illustrative syntax:

TABLE 9

| | |
|---|---|
| Syntax | {[node=<node keys>]& [data =<data keys>]} |
| | —————————————————————————— |

### Scope of Search

Currently, the “depth” of the search will find only the parent and all its children.
The syntax combines both the node and data qualifier.
If you do not specify a specific key word for “keys,” then the query will return all the nodes and their descendents, within the specified scope
DATA is case sensitive

### Instruct to Define the Scope of the XML

Do not omit the node qualifier.
The data qualifier is optional.
Replace “node keys” qualifier text with any full or partial element, attribute or tag names on which to base the search.
Replace “data keys” qualifier text with a keyword for the search to return all the tag nodes that contain the keyword within their text.

### Caution

The following cautions apply to this portion of the query:
Use the [ ] notation characters, omitting the | after making a selection. The [ ] pattern in node is pattern ranger specifier. Checkpattern recognition section.
Replace the underscore with either a space character or the %20 characters. Replace the = symbol with %3D characters.

### EXAMPLES

Because XML queries are used for applications, see the section that contains Customer-specific examples.

### Data

### Purpose

Use data to create a combined node and data searches

The following table sets forth illustrative syntax:

TABLE 10

| | |
|---|---|
| Syntax | node=<node keys>&data=<data keys> |
| | —————————————————————————— |

### Instruct to Create a Combined Node and Data Search

Do not omit the data qualifier.
To create a combined node and data search, use the ampersand before data
DATA is not case sensitive

### EXAMPLES

Because XML queries are used for applications, see the section that contains Customer-specific examples.

### MODX

### Purpose

Use the modx parameter to:
Define an extended XML pattern search
Increase the complexity of the query and or pattern.

### Best Practice

Using the modx parameter is a best practice recommendation for database usage.
modx is particularly useful if information is xml segmented and the desired result is composition.

The following table sets forth illustrative syntax:

TABLE 11

| | |
|---|---|
| Syntax | [modx=< xml pattern> ... text pattern ... |
| | [nested xml pattern]</>] |
| | —————————————————————————— |

### More Information

For more information, please see

http://www.ietf.org/html.charters/webday-charter.html

http://www.webdav.org

### Instruct to Set the Modx Pattern

Combine a node and node searches with “< >” xml delimiters. In tag attributes definitions follow xml specifications.
Use this option to perform database searches to a specific collection of information.

### Relation to WebPAV

The system or method preferably complies with the WebDAV standard so thai standard UI interface can drag and drop information into what appear to be folders on their desktops.
When that happens, the documents and XML documents are parsed, and stored in the database.
This process enables full text searches and makes the ‘upload’ process to the server invisible to the user

### Caution

The following cautions apply to this portion of the query:
Use the [ ] notation characters, omitting the | after making a selection. The [ ] pattern in node is pattern ranger specifier. Checkpattern recognition section.
Replace the underscore with either a space character or the %20 characters. Replace the = symbol with %3D characters.
   A.XSL, with Stylesheet

### Purpose

Use the A.xsl stylesheet file to:
Transform the output of a standard node, data and modx query to a display that includes all the search terms in highlights, all the sections with content that match the search terms as a separate paragraph, and links to the source files.

Note: This style sheet (A.XSL) will work with any query combinations.

The following table sets forth illustrative syntax:

TABLE 12

| | |
|---|---|
| | —————————————————————————— |
| Syntax | http://127.0.0.1/ofxi?xslt=/home/ |
| | style1.xsl&node=name&data=anderson |
| | —————————————————————————— |

### Instructions

If customizing this example for your own use, replace the following:
127.0.0.1 with your server address
name with your node to be searched
anderson with your data to be searched
stylel.xsl with the path to the location of your stylesheet on your server.

### Node and Data Query

### Purpose

Use the node and data portion of the query to:
Obtain both specific contents of documents within a specific context scope
expressed in the default syntax.

The following table sets forth illustrative syntax:

TABLE 13

| | |
|---|---|
| | —————————————————————————— |
| Syntax | http://127.0.0.1/ofxi?xslt=/home/ |
| | style1.xsl&node=name&data=anderson |
| | —————————————————————————— |

### Instructions

If customizing this example for your own use, replace the following:
127.0.0.1 with your server address
name with your node to be searched
the key word anderson with the name of your data to be searched

### Job Aid: Detailed Samples for Customers

### Purpose

### How to Use

The following section contains detailed examples for typical business cases your customers may require
Use them as starting points in developing requirements for custom queries
Collect feedback and report back to your manager and the developer community
Add your own, using this format as a template

### Example 1

In the following example, the system or method found information originally stored as a transformed the information into xml and presented the results as a web page in ‘raw’ format.

TABLE 14
Example 1
Sample Ouput in Raw Format for a list of multiple files associated with a
Query.

| | |
|---|---|
| Query | http://127.0.0.1/ofxi?node=Abstract&data=safety |
| | Note: the output contains more information; |
| Output | <?xml version=\″1.0\″?> |
| | <fx:uri name=″nlm.xml″ date=″″ user=″nlm″ size=″174928″/> |
| | <fx:ofx udrx=″0000014000000100101940″/> |
| | < [symbol] department=”medicine” serial=”ABC.345.XY”> |
| | <AbstractText> |
| | The technique of early extubation after coronary artery |
| | bypass grafting is increasing in popularity, but its [symbol] |
| | and effect on myocardial ischaemia remain to be |
| | established ... |
| | </AbstractText> |
| | </Abstract> |
| | <fx:uri name=″arts.xml″ date=″″ user=″artist″ size=″1728″/> |
| | <fx:ofx udrx=″0000014000000100101940″/> |
| | < [symbol] number=”12345”> |
| | <Art> |
| | Abstract Art is art that is not an accurate representation |
| | of a form or object... |
| | </Art> |
| | </Abstract> |
| | <fx:uri name=″doc.doc″ date=″″ user=″facility″ size=″4928″/> |
| | <fx:ofx udrx=″0000014000000100101940″/> |
| | <![CDATA We consider the [symbol] of the population is at risk]]> |

### Example 2

In the following example, the system or method found information originally stored as a transformed the information into xml and presented the results as a web page in ‘raw’ format.

TABLE 15
Example 2
Sample Output in Raw Format for a list of multiple files associated
with a Query.

| | |
|---|---|
| Query | http://127.0.0.1/ |
| | ofxi?node=Abstract_and_Department=medicine |
| | Note: the query contains an algebraic operator “_and_.” More |
| | information on the algebra is in later sections. |
| Output | <?xml version=\″1.0\″?> |
| | <fx:uri name=″nlm.xml″ date=″″ user=″nlm″ size=″174928″/> |
| | <fx:ofx udrx=″0000014000000100101940″/> |
| | < [symbol] serial=”ABC.345.XY”> |
| | <AbstractText> |
| | The technique of early extubation after coronary artery |
| | bypass grafting is increasing in popularity, but its safety and |
| | effect on myocardial ischaemia remain to be established ... |
| | </AbstractText> |
| | </Abstract> |

### Example 3

In the following example, the system or method found information originally stored as a transformed the information into xml and presented the results as a web page in ‘raw’ format.

TABLE 16
Example 3
Sample Output in Raw Format for a list of multiple files associated with a
Query.

| | |
|---|---|
| Query | http://127.0.0.1/ofxi?data=safety_or_establish* |
| | Note: the query contains an algebraic operator “_or_.” More |
| | information on the algebra is in later sections. |
| Output | <?xml version=\″1.0\″?> |
| | <fx:uri name=″nlm.xml″ date=″″ user=″nlm″ size=″174928″/> |
| | <fx:ofx udrx=″0000014000000100101940″/> |
| | <Abstract department=”medicine” serial=”ABC.345.XY”> |
| | <AbstractText> |
| | The technique of early extubation after coronary artery |
| | bypass grafting is increasing in popularity, but its ␣ |
| | and effect on myocardial ischaemia remain to be |
| | [symbol] ... |
| | </AbstractText> |
| | </Abstract> |

### Example 4

In the following example, the system or method found information originally stored as a transformed the information into xml and presented the results as a web page in ‘raw’ format.

TABLE 17
Example 4
Sample Output in Raw Format for a list of multiple files associated with a
Query.

| | |
|---|---|
| Query | http://127.0.0.1/ofxi?modx= |
| | <Abstract _and_{—} department=”medicine”> |
| | <AbstractText>safety _and_{—} established</></> |
| | Note: the query contains an algebraic operator “_and_{—} ” More |
| | information on the algebra is in later sections. |
| Output | <?xml version=\″1.0\″?> |
| | <fx:uri name=″nlm.xml″ date=″″ user=″nlm″ size=″174928″/> |
| | <fx:ofx udrx=″0000014000000100101940″/> |
| | < [symbol] department=”medicine” serial=”ABC.345.XY”> |
| | <AbstractText> |
| | The technique of early extubation after coronary artery |
| | bypass grafting is increasing in popularity, but its [symbol] |
| | and effect on myocardial ischaemia remain to be |
| | [symbol] ... |
| | </AbstractText> |
| | </Abstract> |

### Algebra

### Purpose

The World-Wide Web Consortium (W3C) promotes XML and related standards, including XML Schema. The albebra is a formalization over XML. A formal semantics based on these ideas is part of the official algebra specification, one of the first uses of formal methods by a standards body. XML features both named and structural types, with structure based on tree grammars. The operators are:
_and_{—}
_or_{—}
_sub_{—}

The following table sets forth illustrative syntax:

TABLE 18

| | |
|---|---|
| | ———————————————————————— |
| Syntax | SET { key [operater ]key } |
| | ———————————————————————— |
| Instructions | http://127.0.0.1/ |
| | ofxi?node=Abstract_and_Department=medicine |

Note:
the query contains an algebraic operator “_and_.” The default white space is an “_or_” operator.

### UDRI Universal Database Record Identifier

### Description

Universal Database Record Identifier (UDRI) is intended to be a subset to the Uniform Resource Locator (URL) and provide an extensible means for identifying universally database records. This specification of URI syntax and semantics is derived from concepts introduced by the World Wide Web global information initiative, and is described in “Universal Resource Identifiers [RFC1630].

### UDRI Syntax

The UDRI syntax is a scheme derived from URI. In general, absolute URI are written as follows:

<scheme>:<scheme-specific-part>

An absolute URI contains the name of the scheme being used (<scheme>) followed by a colon (“:”) and then a string (the <scheme-specific part>) whose interpretation depends on the scheme.

### Example 5

### Query

http://127.0.0.1/ofxi!udrx=0000014000000100101940

Note: the query contains a unique identifier to the record.

The following table sets forth illustrative ouptut:

TABLE 19
Output

```
<?xml version=\″1.0\″?>
<fx:uri name=″nlm.xml″ date=″″ user=″nlm″ size=″174928″/>
<fx:ofx udrx=″0000014000000100101940″/>
< [symbol]  department=”medicine” serial=”ABC.345.XY”>
  <AbstractText>
    The technique of early extubation after coronary artery bypass
    grafing is increasing in popularity, but its [symbol]  and effect on
    myocardial ischaemia remain to be [symbol]  ...
  </AbstractText>
</Abstract>
```

### Unexpected Results

### Symptom

One example is an error in the style sheet thai prevents the expected output from formatting correctly.

### More Symptoms

The results should be xml but are not
The results are not a recomposed document, but should be
The layout is not correct
Parts of the expected contents are missing
The titles and the contents do not match the content requested

### Solution

Check the version of the Query being used.
Check the syntax of the query
Check the full path to the required information source
Check the full path to the required output file
Check the syntax inside the associated style sheet or template
Check the configuration file/scripts such licensing keys
Check permission on data and data access
Check log files for errors
Check Access Control
Check the server publishing the results for outages.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for querying a database, comprising receiving a query from a client, querying a plurality of databases, receiving replies from the databases, relaying the replies from the databases to the client as they are received from the databases.

2. A system for querying a database, comprising a client, a plurality of databases, and a query dispatcher receiving a query from the client, querying the plurality of databases, receiving replies from the databases, relaying the replies from the databases to the client as they are received from the databases.
